(19) United States
(12) Patent Application Publication
(10) Pub. No.: US 2013/0215007 A1
(43) Pub. Date: Aug. 22, 2013

(54) PORTABLE ELECTRONIC DEVICE AND CONTROL METHOD THEREOF

(71) Applicant: Li-Te HUNG, Taipei City (TW)

(72) Inventor: Li-Te HUNG, Taipei City (TW)

(73) Assignee: QUANTA COMPUTER INC., Tao Yuan Shien (TW)

(21) Appl. No.: 13/484,263

(22) Filed: May 30, 2012

(30) Foreign Application Priority Data
Feb. 21, 2012 (TW) 101105702

(51) Int. Cl. G06F 3/01

(52) U.S. Cl. 345/156

(57) ABSTRACT

A portable electronic device including a control unit, an ambient light sensor, a proximity sensor and a panel is provided. The ambient light sensor is electrically connected to the control unit. The proximity sensor is electrically connected to the control unit. The panel is electrically connected to the control unit. When the portable electronic device is in a normal operation state and the panel is in an enabled state, if the ambient light sensor detects that the ambient light is dark and the proximity sensor detects that an object is close to a predetermined distance, the control unit switches the portable electronic device into one of a sleep mode, a hibernation mode or a shutdown mode, otherwise, the portable electronic device maintains in the normal operation state.

This application claims the benefit of Taiwan application Serial No. 101105702, filed Feb. 21, 2012, the subject matter of which is incorporated herein by reference.

### BACKGROUND OF THE INVENTION

1. Field of the Invention

The disclosure relates in general to a portable electronic device and a control method thereof.

2. Description of the Related Art

The conventional laptop computer detects whether a lid or cover is closed relative to a base according to the interaction between a magnet disposed on the cover and a Hall sensor disposed on the base. However, the disposition of magnet and Hall sensor not only occupies extra space in the laptop computer but also increases manufacturing cost.

### SUMMARY OF THE INVENTION

The disclosure is directed to a portable electronic device and a control method thereof in which the open-close state of a cover is automatically detected by a sensor.

According to a first aspect of the present disclosure, an ambient light sensor, a proximity sensor and a panel is provided. The ambient light sensor is electrically connected to the control unit. The proximity sensor is electrically connected to the control unit. The panel is electrically connected to the control unit. When the portable electronic device is in a normal operation state and the panel is in an enabled state, if the ambient light sensor detects that the ambient light is dark and the proximity sensor detects that an object is close to a predetermined distance, then the control unit switches the portable electronic device into one of a sleep mode, a hibernation mode or a shutdown mode, otherwise, the portable electronic device maintains in the normal operation state.

According to a second aspect of the present disclosure, a method for controlling a portable electronic device is provided. The portable electronic device includes a control unit, an ambient light sensor, a proximity sensor and a panel. The ambient light sensor is electrically connected to the control unit. The proximity sensor is electrically connected to the control unit. The panel is electrically connected to the control unit. The method for controlling a portable electronic device includes the following steps. An ambient light is detected by an ambient light sensor. An object is detected by a proximity sensor. When the portable electronic device is controlled to be in a normal operation state and the panel is in an enabled state, if the ambient light sensor detects that the ambient light is dark and the proximity sensor detects that the object is close to a predetermined distance, then the control unit switches the portable electronic device into one of a sleep mode, a hibernation mode or a shutdown mode, otherwise, the portable electronic device maintains in the normal operation state.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of an example of a portable electronic device according to an embodiment; and

FIG. 2 shows a block diagram of another example of a portable electronic device according to an embodiment.

### DETAILED DESCRIPTION OF THE INVENTION

According to the portable electronic device and control method thereof of the disclosure, the open-close state of a cover is determined by using an ambient light sensor and a proximity sensor for automatically controlling the state of the electronic device.

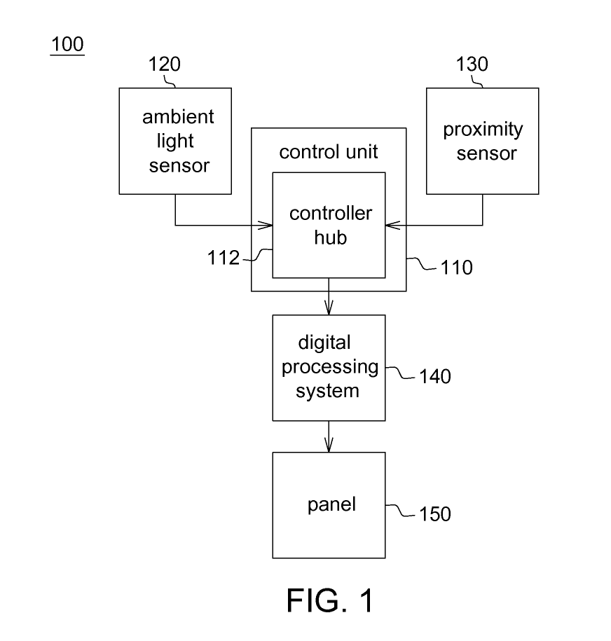

Referring to FIG. 1, a block diagram of an example of a portable electronic device according to an embodiment is shown. The portable electronic device 100, such as a laptop computer, includes a control unit 110, an ambient light sensor 120, a proximity sensor 130, a digital processing system 140 and a panel 150. In the present embodiment, the control unit 110 includes a controller hub 112, realized by such as a platform controller hub (PCH) or a fusion controller hub (FCH) according to the design architecture of the control unit 110. In addition, the digital processing system 140 is optional element. In one embodiment, the electronic device 100 comprises a base (not shown) and a cover (not shown) that is able to open or close relative to the base. In one embodiment, the control unit 110, the ambient light sensor 120, the proximity sensor 130, and the digital processing system 140 are disposed in the base of the electronic device 100. In one embodiment, the ambient light sensor 120 and the proximity sensor 130 could be disposed either on the upper surface of the base facing the cover or disposed on the lower surface of the cover facing the base.

The ambient light sensor 120 is electrically connected to the controller hub 112 of the control unit 110. The proximity sensor 130 is electrically connected to the controller hub 112 of the control unit 110. The digital processing system 140 is electrically connected to the controller hub 112 of the control unit 110. The panel 150, substantially disposed on the cover of the electronic device 100, is electrically connected to the control unit 110 via the digital processing system 140. The electronic device 100 substantially may perform setting with a basic I/O system (BIOS) coupled to the controller hub 112 or an application program to activate the function of determining the open-close state of the cover by using the ambient light sensor 120 and the proximity sensor 130. In addition, the portable electronic device 100 also has corresponding setting on the operating system (OS) according to the open-close state of the cover.

When the portable electronic device 100 is in a normal operation state and the panel 150 is in the enabled state, if the ambient light sensor 120 detects that the ambient light is dark and the proximity sensor 130 detects that an object, such as the cover or the base, is close to a predetermined distance, then the controller hub 112 determines that the cover is closed with respect to the portable electronic device 100. Then, the controller hub 112 controls the digital processing system 140 to make the portable electronic device 100 enter a predetermined state, such as a sleep mode, a hibernation mode or a shutdown mode. In an implementation, when the portable electronic device 100 enters any of the above modes, the digital processing system 140 further switches the panel 150 into a disable state.

In an implementation, the ambient light is determined as dark if the luminance of the ambient light is lower than 100 luminance (Im). In an implementation, the predetermined distance detected by the proximity sensor 130 is 4 mm. However, the settings of 100 Im and 4 mm are dependent on actual needs and are not for limiting the scope of the disclosure. Conversely, if the above two conditions are not both satisfied, then the controller hub 112 determines that the cover open with respect to the portable electronic device 100. Meanwhile, the portable electronic device 100 maintains its current state (the normal operation state) without performing any action, and the panel 150 also maintains its current state (enabled state) without performing switching. Thus, the portable electronic device 100 of the present embodiment of the disclosure may detect the open-close state of the cover with the use of the ambient light sensor 120 and the proximity sensor 130 conforming to the standards of the industries, and conventional use of magnet and Hall sensor can thus be omitted.

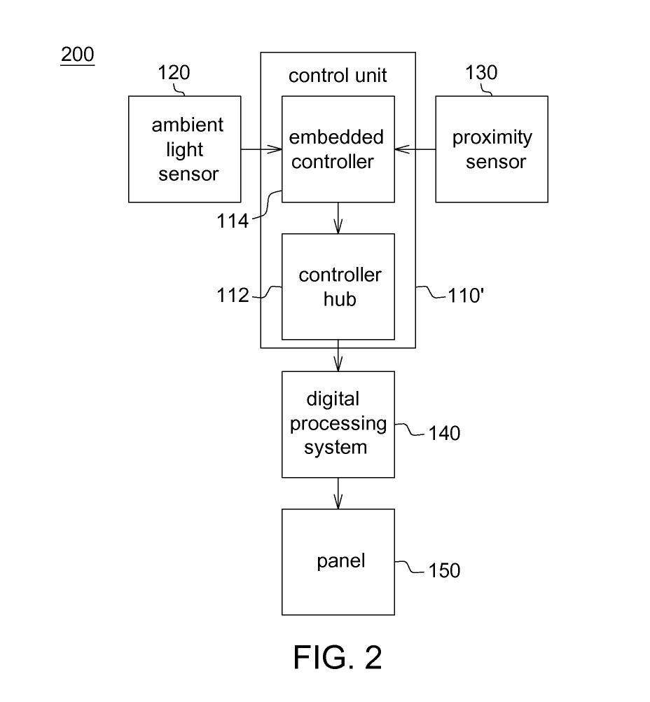

Referring to FIG. 2, a block diagram of another example of a portable electronic device according to an embodiment is shown. The structure of the portable electronic device 200 is similar to that of the portable electronic device 100 and the only difference lies in the control unit 110′. In comparison to the control unit 110, the control unit 110′ further includes an embedded controller 114 electrically connected to the ambient light sensor 120 and the proximity sensor 130. The controller hub 112 is electrically connected to the embedded controller 114 and the digital processing system 140. The design architecture of the control unit 110′ is dependent on the design needs.

When the panel 150 is in an enabled state, if the ambient light sensor 120 detects that the ambient light is dark and the proximity sensor 130 detects that the object is close to the predetermined distance, then the embedded controller 114 determines that the cover is closed with respect to the portable electronic device 200. Then, the embedded controller 114 informs the controller hub 112, which controls the digital processing system 140 to make the portable electronic device 200 enter a predetermined state, such as a sleep mode, a hibernation mode or a shutdown mode. In an implementation, when the portable electronic device 200 enters any of the above modes, the control unit 110 further controls the digital processing system 140 to switch the panel 150 into a disable state.

In the present embodiment of the disclosure, if the ambient light sensor 120 detects that the ambient light is dark, but the proximity sensor 130 does not detect that the object is close to the predetermined distance, then the two conditions for determining that the screen are not both satisfied. Such scenario may occur when the electronic device 100 experiences an environment change (for example, the user takes the electronic device 100 indoor from outdoor) or the ambient light is turned off (for example, the user turns off the indoor light). Meanwhile, the control unit 110 does not perform any action, the portable electronic device 100 maintains its current state (normal state) without performing any action and the panel 150 maintains at enabled state. For example, the user turns off the indoor light to view a film with the portable electronic device 100. Meanwhile, the ambient light sensor 120 detects that the ambient light is dark but the proximity sensor 130 does not detect that any object is close in the predetermined distance. If the control unit 110 turns off the panel 150 automatically, that would be contradictory to the user's expectation of viewing a film with the portable electronic device 100 in a dark environment. Thus, due to both condition not satisfied, the panel 15 would maintain at current enabled state.

In addition, if the proximity sensor 130 detects that the object is close to the predetermined distance but the ambient light sensor 120 does not detect that the ambient light is dark, which may occur when an object other than the cover accidentally touches the proximity sensor 130 (for example, the user's palm), then the conditions for determining the cover as being closed are not satisfied. Meanwhile, the control unit 110 does not perform any action, the portable electronic device 100 maintains its current state (normal state) without performing any action, and the panel 150 also maintains the enabled state. For example, when the user hold the device or uses an input device (such as a press key or touch screen) of the portable electronic device 100, the user's finger may accidentally enter the detection range of the proximity sensor 130. Under such circumstances, it would be contradictory with the user's expectation of continually using the portable electronic device 100 if the control unit 110 turns off the panel 150.

In an implementation, the digital processing system 140 is a optional element, that is, the controller hub 112 is electrically connected to the panel 150 directly for controlling the enabled/disabled state of the panel 150. In an implementation, the ambient light sensor 120 and the proximity sensor 130 may directly be electrically connected to the panel 150 which performs activation or switching according to the above conditions.

The disclosure further provides a method for controlling a portable electronic device, which includes a control unit, an ambient light sensor, a proximity sensor, an optional digital processing system and a panel. The ambient light sensor is electrically connected to the control unit. The proximity sensor is electrically connected to the control unit. The digital processing system is electrically connected to the control unit. The panel is electrically connected to the digital processing system. The method for controlling a portable electronic device includes the following steps. An ambient light is detected by the ambient light sensor. An object is detected by the proximity sensor. When the portable electronic device is controlled to be in a normal operation state and the panel is in an enabled state, if the ambient light sensor detects that the ambient light is dark and the proximity sensor detects that the object is close to a predetermined distance, then the control unit controls the digital processing system to switch the state of the portable electronic device and that of the panel.

The principles of the method for controlling a portable electronic device are disclosed in the descriptions of the portable electronic devices 100 and 200 and associated contents, and are not repeated here.

According to the portable electronic device and control method thereof of the disclosed embodiments of the disclosure, the open-close state of a cover is detected with the ambient light sensor and the proximity sensor conforming to the standards of the industries. By doing so, the state of the panel is automatically controlled, the user's desired situations are determined more accurately, conventional use of magnet and Hall sensor can thus be omitted, and the manufacturing cost and power consumption are both reduced.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable electronic device, comprising:
a control unit;
an ambient light sensor electrically connected to the control unit;
a proximity sensor electrically connected to the control unit; and
a panel electrically connected to the control unit;
wherein, when the portable electronic device is in a normal operation state and the panel is in an enabled state, if the ambient light sensor detects that the ambient light is dark and the proximity sensor detects that an object is close to a predetermined distance, the control unit switches the portable electronic device into a sleep mode, a hibernation mode or a shutdown mode, otherwise, the portable electronic device maintains in the normal operation state.

2. The portable electronic device according to claim 1, wherein when the control unit switches the portable electronic device to the sleep mode, the hibernation mode or the shutdown mode, the control unit further switches the panel into a disabled state.

3. The portable electronic device according to claim 1, wherein the object is a cover on which the panel is disposed.

4. The portable electronic device according to claim 1, wherein the control unit comprises:
a controller hub electrically connected to the ambient light sensor and the proximity sensor.

5. The portable electronic device according to claim 1, wherein the control unit comprises:
an embedded controller electrically connected to the ambient light sensor and the proximity sensor; and
a controller hub electrically connected to the embedded controller.

6. The portable electronic device according to claim 1, wherein if the ambient light sensor detects that the luminance of the ambient light is lower than 100, the ambient light is determined as dark, and the predetermined distance is 4 mm.

7. A method for controlling a portable electronic device, wherein the portable electronic device comprises a control unit, an ambient light sensor, a proximity sensor, and a panel, and the method for controlling a portable electronic device comprises:
detecting the ambient light by the ambient light sensor;
detecting an object by the proximity sensor; and
when the portable electronic device is in a normal operation state and the panel is in an enabled state, if the ambient light sensor detects that the ambient light is dark, and the proximity sensor detects that the object is close to a predetermined distance, then the control unit switches the portable electronic device into a sleep mode, a hibernation mode or a shutdown mode, otherwise, the portable electronic device maintains in the normal operation state.

8. The method for controlling a portable electronic device according to claim 7, wherein when the control unit switches the portable electronic device to the sleep mode, the hibernation mode or the shutdown mode, the control unit further switches the panel into a disabled state.

9. The method for controlling a portable electronic device according to claim 7, wherein the object is a cover on which the panel is disposed.

10. The method for controlling a portable electronic device according to claim 7, wherein if the ambient light sensor detects that the luminance of the ambient light is lower than 100, then the ambient light is determined as dark, and the predetermined distance is 4 mm.
